(19) United States
(12) Patent Application Publication
(10) Pub. No.: US 2011/0023349 A1
(43) Pub. Date: Feb. 3, 2011

(54) Device to lift a motion decoy

(76) Inventor: Dennis Hughes, Metropolis, IL (US)

Correspondence Address: Larry E Severin, Esq, 3581 Teaberry Circle, Seal Beach, CA, 90740, US

(21) Appl. No.: 12/846,700

(22) Filed: Jul. 29, 2010

Related U.S. Application Data
(60) Provisional application No. 61/229,437, filed on Jul. 29, 2009.

(51) Int. Cl. A01M 31/06

(52) U.S. Cl. 43/3; 43/2

(57) ABSTRACT

A device to lift a motion decoy includes a main chamber; a piston that extends inside and outside of the main chamber; an end of the piston outside of the main chamber adapted to connect to the decoy; a gasket on the piston, inside the main chamber, that helps the pressure of the water urge the piston to rise so that the piston lifts and lowers the decoy, the gasket helping stabilize the piston relative to the main chamber when the piston has risen; a water pump that provides the main chamber with water under pressure so as to urge the piston to rise; and a contact switch on the piston that, upon lack of contact between the contact switch and the main chamber, allows the decoy to activate a motion. An inner piston may rise out of the piston to further lift the decoy.

### RELATED APPLICATIONS

This application claims the benefit of the filing date of U.S. Patent Application No. 61/229,437, filed Jul. 29, 2009, which is incorporated herein by reference in its entirety.

### BACKGROUND OF THE INVENTION

The present invention generally relates to decoys and more specifically to a device to lift a motion decoy.

Existing decoys and decoy systems do not have lifelike flight motion.

It would be desirable to have a decoy system with lifelike flight motion that stops the motion when the decoy appears to land.

### SUMMARY OF THE INVENTION

In one aspect of the present invention, a device to lift a decoy includes a main chamber; a piston that extends inside and outside of the main chamber, an end outside of the main chamber adapted to connect to the decoy; and a pump that provides the main chamber with pressure so as to urge the piston to rise, thereby lifting the decoy.

In another aspect of the present invention, a device to lift a decoy includes a main chamber; a piston that extends inside and outside of the main chamber; an end of the piston outside of the main chamber adapted to connect to the decoy; a gasket on the piston, inside the main chamber, that helps the pressure of the water urge the piston to rise so that the piston lifts and lowers the decoy, the gasket helping stabilize the piston relative to the main chamber when the piston has risen; a water pump that provides the main chamber with water under pressure so as to urge the piston to rise; and a contact switch on the piston that, upon lack of contact between the contact switch and the main chamber, allows the decoy to activate a motion.

In yet another aspect of the present invention, a method of simulating a bird in flight and then landing includes pumping water into a main chamber; activating a motion for a decoy; utilizing water pressure in the main chamber to lift a piston attached to the decoy, thereby lifting the decoy; pressing the water out of the main chamber, thereby lowering the piston and the decoy; and upon contact between the main chamber and the piston, deactivating the motion for the decoy.

### BRIEF DESCRIPTION OF THE DRAWINGS

FIG. 1 depicts a side view of an embodiment of the present invention;

FIG. 2 depicts the embodiment of FIG. 1 with the pump on;

FIG. 3 depicts the embodiment of FIG. 1 with the pump off;

FIG. 4 depicts a perspective view of a three stage embodiment of the present invention;

FIG. 5 depicts a side view of main chamber cylinder “A” of the embodiment of FIG. 4;

FIG. 6 depicts a side view of piston cylinder “B” of the embodiment of FIG. 4;

FIG. 7 depicts a side view of inner piston cylinder “C” of the embodiment of FIG. 4;

FIG. 8 depicts an exploded view of an embodiment of the present invention utilizing a steel rod;

FIG. 9 depicts a side view of an embodiment of a stake according to the present invention;

FIG. 10 depicts a perspective view of an embodiment of a stand according the present invention; and

FIG. 11 depicts a side view of the embodiment of FIG. 10.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a device to lift a motion decoy. An embodiment of the present invention may generally use water pressure from a bilge pump to fill a chamber to provide a lift for one or more pistons to lift a decoy so as to provide a vertical lift. Embodiment of the present invention may add up and down motion to a decoy to create the illusion of a fowl, waterfowl, or other decoy resembling a bird in flight and landing. The system may use a water pump controlled by the operator to raise a motion decoy to allow for lifelike flight and stopping the motion when the decoy is landed.

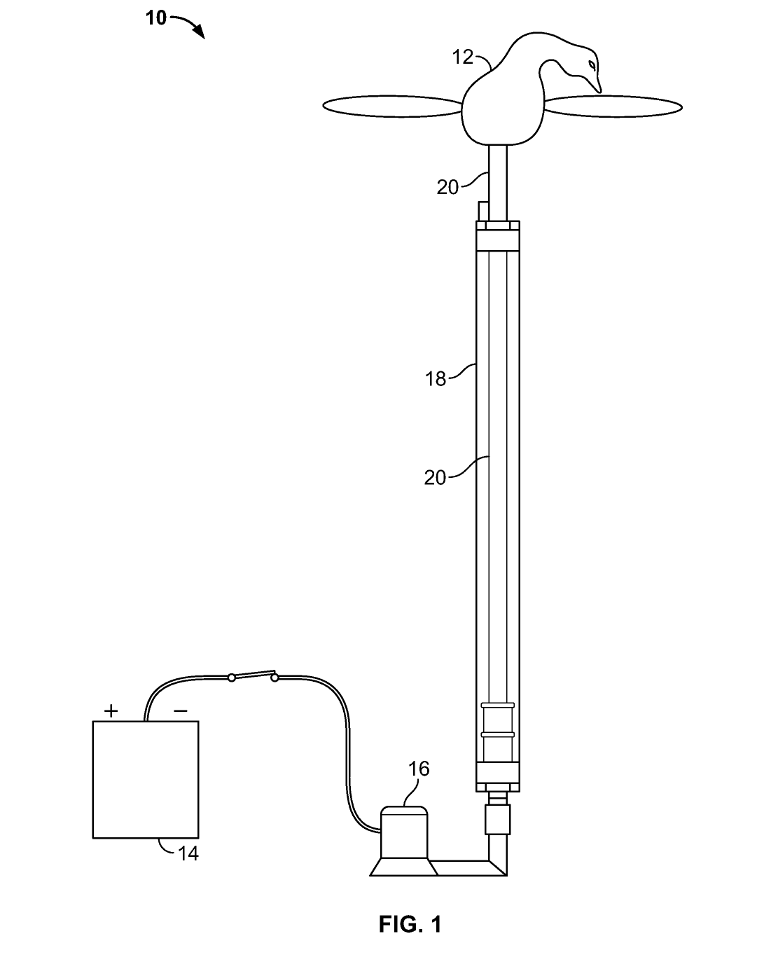

As depicted in the embodiment of FIG. 1, a device 10 may lift a decoy 12 utilizing a power source 14 that powers a pump 16, which is connected to a main chamber 18 with a piston 20. Embodiments of power source 14 may include, but are not limited to, an internal or external 12 volt battery, power generator, inverter, or power cable. Embodiments of pump 16 may include, but are not limited to, a 12 volt bilge pump and a connector hose to connect to main chamber 18. Embodiments of pump 16 may be a bilge pump or other pump, where the gallons per hour (GPH) of the pump are adequate to lift a piston. Pump 16 may connect to main chamber 18, which may be a conduit such as, for example, a 1¼″ inch (1¼″) substantially polyvinyl chloride (PVC) cylinder. Samples have been successfully tested with 2″ PVC and may be larger. Piston 20 may serve as the piston that provides the up and down vertical lift. Piston 20 may include ¾″ PVC, which has been found to provide stability when utilized with a 12-volt bilge pump. The diameter of piston 20 could be larger if a larger pump 16 were used.

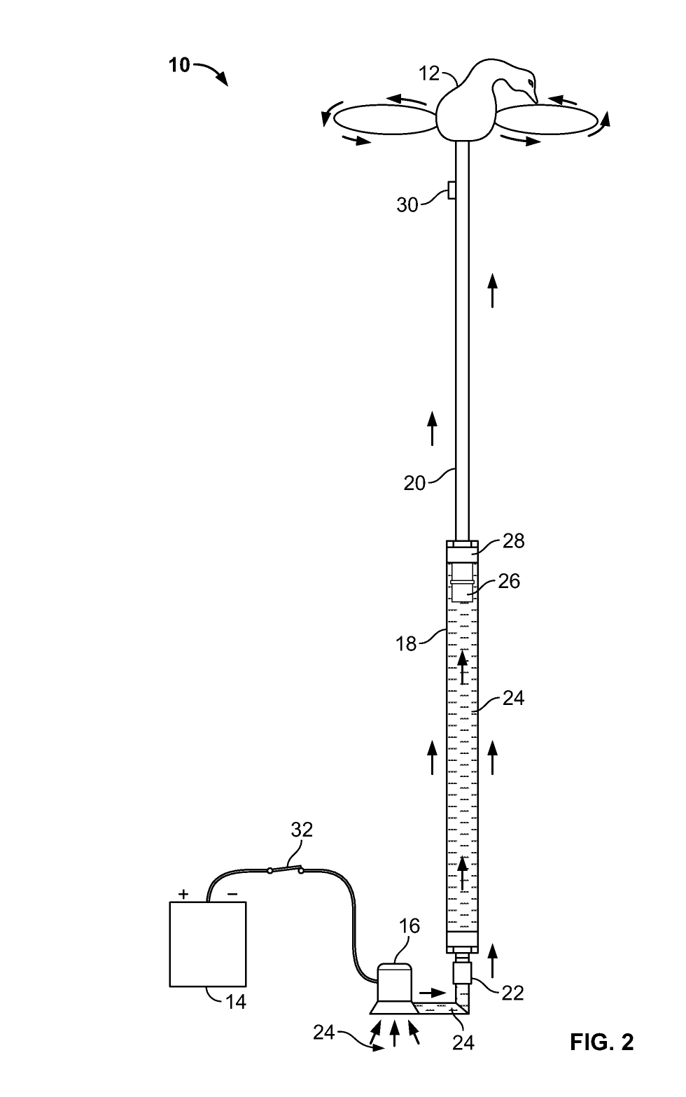

FIG. 2 depicts the embodiment with pump power switch 32 in the “ON” position, with pump 16 running so as to raise and/or support the decoy 12. When power source 14 is activated, water pump 16 may activate to allow water 24 to flow through a quick connect fitting 22 into the bottom of main chamber 18. As the bottom of main chamber 18 fills with water 24, pressure may be applied against a piston cap 26 glued or otherwise attached to the bottom of piston 20, which may urge piston 20 to rise toward a main coupling 28 or cap near the top of main chamber 18 and raise the decoy 12. A contact switch 30 or other motion sensor may activate and deactivate the wings of decoy 12. When piston 20 reaches its maximum height, fittings may provide stability for piston 20 and the motion decoy 12.

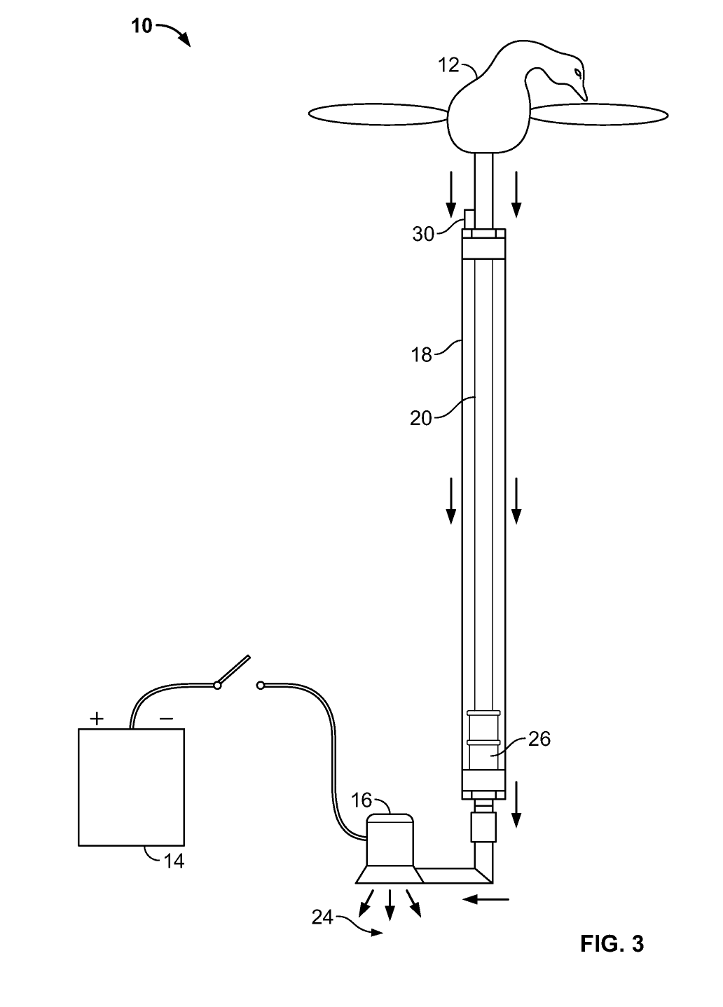

FIG. 3 depicts the embodiment in the downward cycle with pump power switch 32 in the “OFF” position. When the power 14 is removed from the pump 16 the weight of the motion decoy 12 on top of piston 20 may push downward, slowly pressing the water 24 out of main chamber 18. The decoy 12 may come to rest when the piston cap 26 on the bottom of piston 20 reaches the bottom of main chamber 18. Depending on the motion decoy to be used, decoy 12 may be wired with contact switch 30 to allow the wings of the decoy to be activated when piston 20 begins to lift from its resting point. The wings or other elements may continue to move as piston 20 completes it designed cycle of lifting and returning to rest on top of main chamber 18. When contact with contact switch 30 is made, the cycle is completed, decoy 12 comes to rest near the top of main chamber 18, and the wings will stop. This may provide the look of a waterfowl rising in flight and returning to rest.

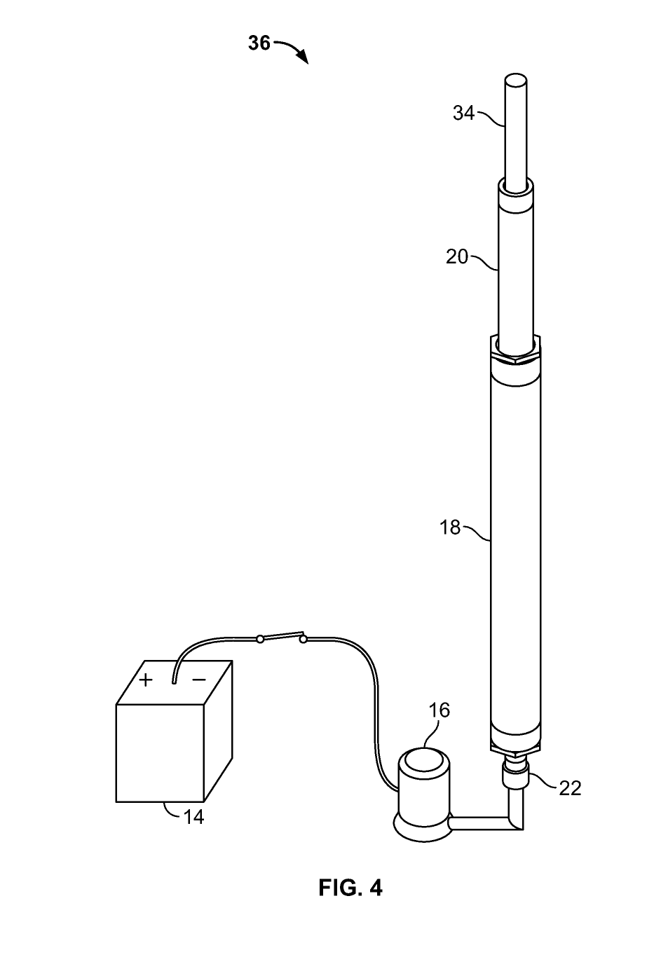

FIG. 4 depicts a three stage embodiment 36 according to the present invention. Piston 20 is a cylinder that rises out of main chamber 18, and inner piston 34 rises out of piston 20 to support the motion decoy. The water pressure that lifts piston 34 may pass through the interior of piston 34 and also lift inner piston 34. The size of inner piston 34 may depend on the size of piston 20 and main chamber 18 since they are dependent on each other and freely fit into each other.

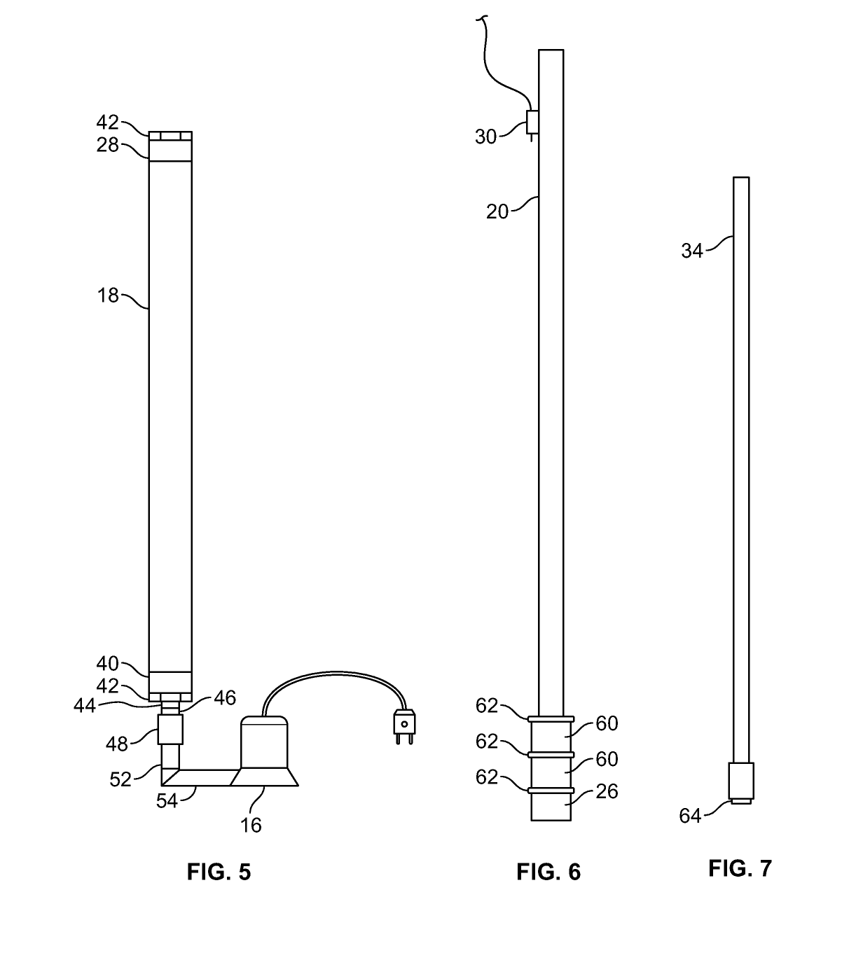

As depicted in FIG. 5, an embodiment of main chamber 18 (which may be called cylinder “A”) may be a 1¼″ PVC cylinder or other tubing that may be, but is not limited to, 12 inches to 48 inches in length. The bottom of main chamber 18 may have a 1¼″ female adapter 40. A 1¼″ by ¾″ PVC hex bushing 42 may thread into the female adapter 40. This hex bushing 42 may allow for access to main chamber 18. A ¾″ male pipe thread (MIP) by ¾″ male hose thread (MHT) adapter 44 may thread into a ¾″ bushing 46 such as a rubber hose washer and ¾″ garden hose quick connect 48, which may allow a hose 52 to connect the pump 16 being used with a ⅝ plastic barbed fitting 54. The other end of main chamber 18 may have a 1¼″ coupling 28 or cap with a 1¼″ by ¾″ PVC slip hex bushing 50. The ¾″ quick-connect bushing must be bored slightly to allow ¾″ PVC to pass freely up and down.

As depicted in FIG. 6, an embodiment of piston 20 (which may be called cylinder “B”) may be ¾″ PVC but can be other sizes. Piston 20 may be approximately 6 inches longer than main chamber 18 to allow for decoy placement. A ¾″ PVC cap 26 is at the bottom and fittings above cap 26 include a plurality of ¾″ piston couplings 60 separated by “O” rings 62 or other gaskets. The “O” rings 62 may be placed in order to help provide a seal for the piston and serve as a stabilizer on the bottom of piston 20. The PVC fittings may be glued in place and separated by a small space for the “O” rings 62.

As depicted in FIG. 7, an embodiment may include an inner piston 34 (which may be called cylinder “C”). Piston 20 may be a cylinder with the top left open, and inner piston 34 may be ½″ PVC fitted into the opening of piston 20. A stop 64 or rubber plug may be located or placed on the bottom of inner piston 34. A ½″ inch inner piston coupling 66 may be located near the bottom of inner piston 34 to help make a seal for the piston and help stabilize the bottom of inner piston 34. The size used for inner piston 34 would depend on the size of main chamber 18 and piston 20 so that inner piston 34 freely slides into piston 20.

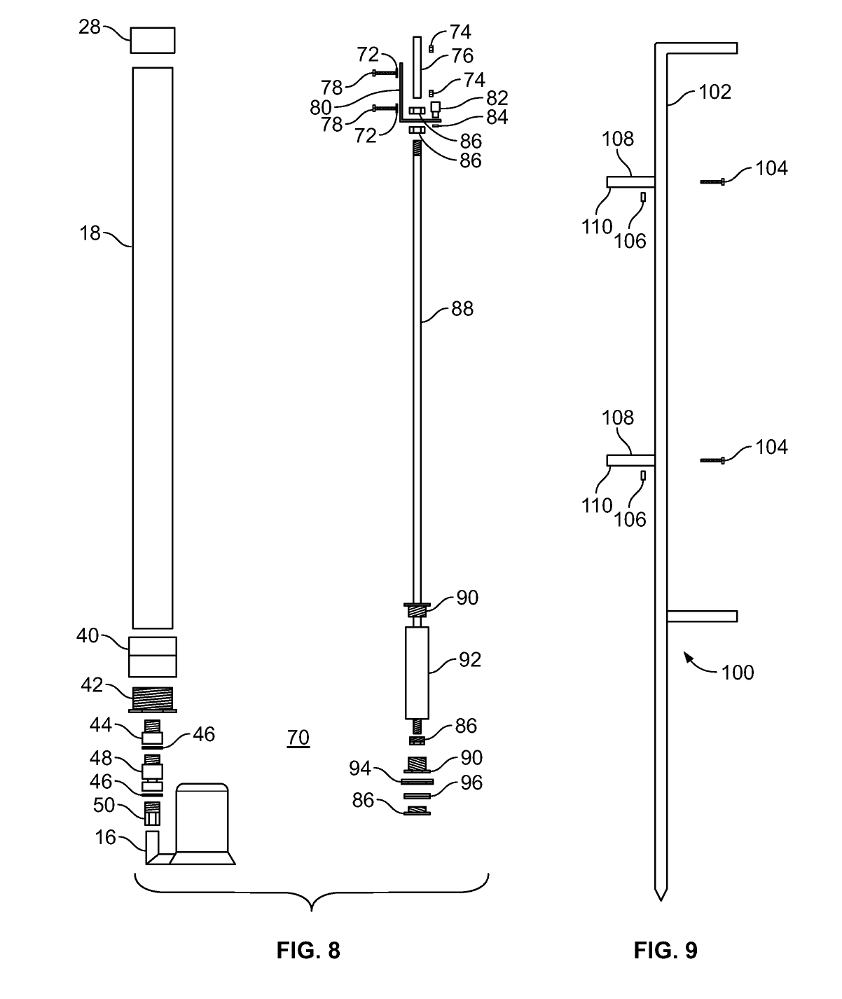

FIG. 8 depicts an exploded, detailed view of an alternate embodiment of a device 70. The outer cylinder “A” is similar to the embodiment of FIG. 1, but the inner piston cylinder “B” has a substantially steel rod in-line, down its center. The outer cylinder may include a 1¼″ PVC coupling 28 or cap at one end of a 1¼″ PVC schedule 40 (SCH40) pipe 18, and at the other end cylinder may be secured with a 1¼″ PVC female adapter 40, a 1¼″×¾″ hex bushing 42 and a ¾″ MIP×¾″ female hose thread (FHT) adapter 44. Two ¾″ bushings 46 or rubber hose washers may surround a hose quick connect 48, which connects through a ¾″ slip×¾″ MHT 50 to a 12 volt pump 16. The inner cylinder may include 4/40 steel washers 72, 4/40 steel nuts 74, 5″ long ¾″ square tubing 76, 4/40×1¼″ steel bolts 78, a 3×3 steel angle bracket 80, a single-pole single-throw (SPST) momentary, normally closed (N/C) switch 82, a switch nut 84, and a ⅜″ nut 86. A ⅜″ steel rod 88 is has a ¾″ PVC threaded plug 90 to retain a 6″ long 1″ PVC tube 92. The bottom of the PVC tube 92 has more ⅜″ nuts 86, another threaded plug 90, a 1½″×⅜″ rubber washer 94, and a 1×⅜″ steel fender washer 96.

FIG. 9 depicts an embodiment of stake 100 that may be utilized to hold a device to lift a motion decoy. Stake 100 may include a section of 5″ long ¾″ square tubing 102, 1¼″×¼″ steel hex bolts 104, ¼″ steel nuts 106, 1¼″ conduit clamps 108, and ¼″ wing nuts 110. The stake 100 may be driven into the ground and that clamps 108 may be utilized to retain an embodiment of the device 10.

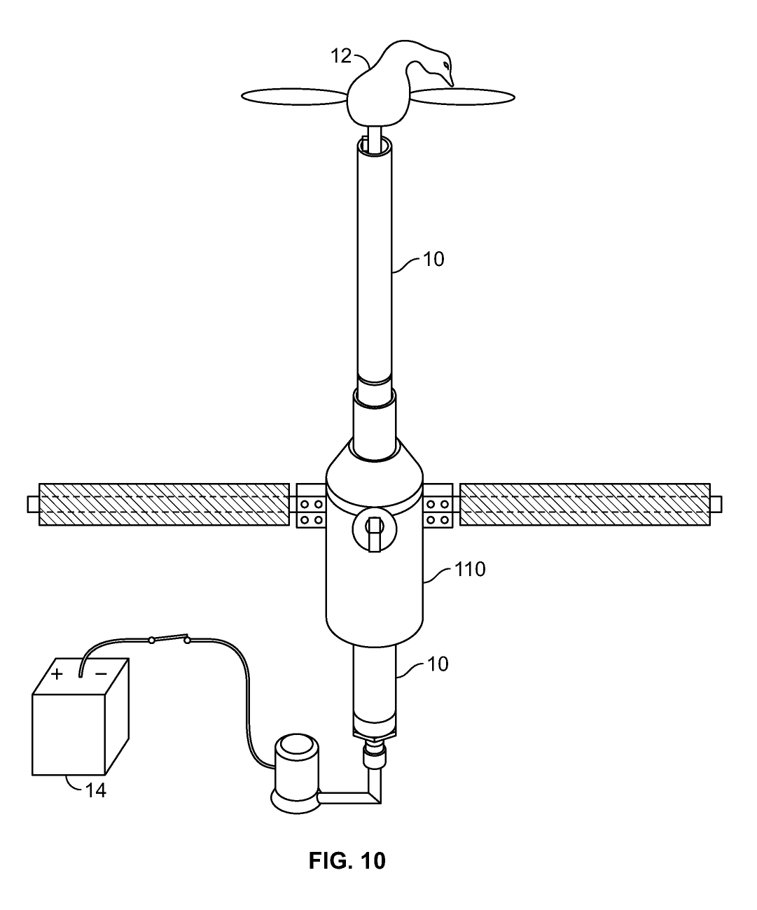

FIG. 10 shows an embodiment of a multipurpose stand 110 with device 10 inserted, as it would be used in water deeper than 18 inches. Embodiments may also include a timing function that may use a proper timing for a lifelike motion decoy. Embodiments may include a multipurpose stand to hold the device, provide a standalone water source, and be used to provide a floating device for deeper water situations.

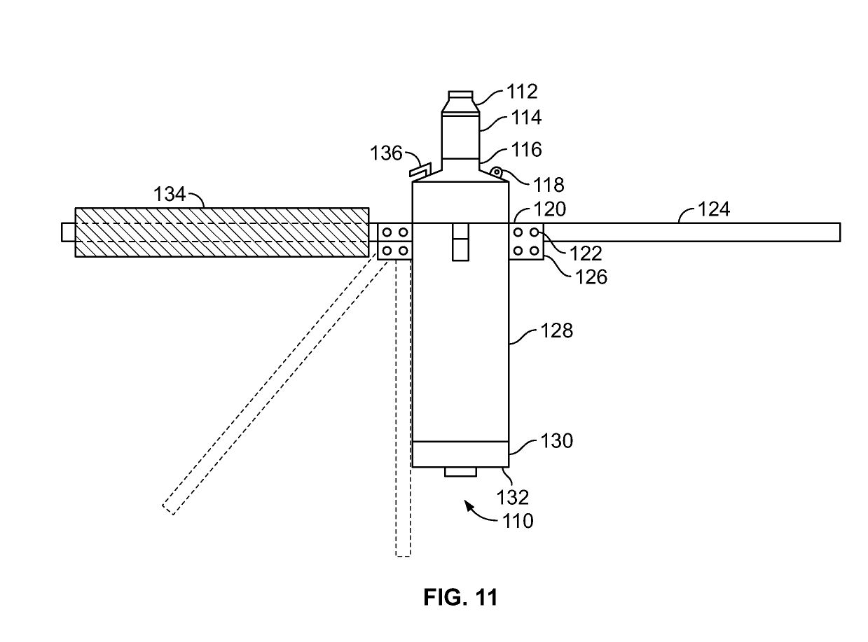

As depicted in FIG. 11, an embodiment of a multipurpose stand 110 may include a section of 4″×12″ PVC pipe 128 to hold a water supply. At the top of the water container is a 2″ by ½″ Fernco or other fitting 112 attached to one end of a section of 6″ long 2″ PVC tubing 114, a 4″×2″ coupling 116, and a waterproof wire inlet 118 to fill the container. At the other end are a 4″ female adapter 130, a 4″ PVC plug 132, and a 1″ boat plug 136. Four 3″×24″ floats 134 are held with a 3″×3″ aluminum angle 126 to four ¾″×24″ square sections of aluminum 124 with four 14″×1½″ stainless steel bolt and stop nuts 120, and four ¼″×1½″ clevis pins 122 or other fasteners. Each float 134 may be put in a first, extended position for use where the float acts as a flotation device for the device, or folded into a second position for storage.

To use an embodiment of the invention, a hunter or other user may take the device to a water source and stand it in the water with a stake or with a multipurpose stand while waterfowl hunting. The device may be connected to 12 volt power source. A motion decoy may be placed on the top of the device. At the desired time the user may activate the device to raise and activate the wings of the decoy. This may allow the decoy to spin for a desired amount of time, or until the user gets the attention of passing fowl and deactivates the device to simulate to the passing fowl that a bird has just landed. This step can be repeated as desired or may be placed on a timer or remote control to repeat. Another embodiment may raise and lower the decoy with no added motion.

An embodiment of a device for a decoy may include a power source, a pump, powered by the power source, the pump providing a source of water, a first cylinder having first and second ends, a first adapter at the first end of the first cylinder, adapted to connect to the source of water, a second cylinder that fits inside the first cylinder, a coupling on the second end of the first cylinder that allows the second cylinder to pass freely up and down, and a gasket between the first and second cylinders. The first cylinder, gasket, and second cylinder may cooperate to provide a piston that lifts and lowers the decoy.

I claim:

1. A device to lift a decoy, comprising:
a main chamber;
a piston that extends inside and outside of the main chamber, an end outside of the main chamber adapted to connect to the decoy; and
a pump that provides the main chamber with pressure so as to urge the piston to rise, thereby lifting the decoy.

2. The device of claim 1, wherein the decoy is a motion decoy resembling a bird in flight.

3. The device of claim 1, wherein the piston rises and then lowers the decoy so as to simulate a bird in flight and then landing.

4. The device of claim 1, further comprising:
a contact switch on the piston;
wherein, upon lack of contact between the contact switch and the main chamber, the device provides power to the decoy.

5. The device of claim 1, the decoy being a motion decoy, further comprising:
a power supply;
the power supply providing power to the pump to raise or support the motion decoy, and the power supply providing power to the motion decoy so that the decoy may move.

6. The device of claim 1, wherein the decoy is a motion decoy having an element that simulates moving a wing of a bird.

7. The device of claim 1, wherein the pump is a water pump having an input adapted to receive water and an output that provides the water under pressure to the main chamber.

8. The device of claim 1, further comprising:
a battery;
wherein the pump is powered by the battery.

9. The device of claim 1, further comprising:
a gasket near a second end of the piston, inside the main chamber, that helps provide a seal so that the pressure of the water urges the piston to rise, thereby lifting the decoy.

10. The device of claim 9, wherein the gasket further helps stabilize the piston relative to the main chamber when the piston has risen.

11. The device of claim 1, further comprising:
a second piston that rises out of the piston, connected to the decoy so as to further lift the decoy, the pump providing pressure that urges both the piston and the second piston to rise.

12. The device of claim 1, wherein the main chamber substantially includes a cylinder of polyvinyl chloride (PVC) and the piston substantially includes a cylinder of PVC.

13. The device of claim 1, wherein the piston includes a cylinder substantially of polyvinyl chloride (PVC) attached in-line to a rod substantially of steel, said steel rod adapted to connect to the decoy.

14. The device of claim 13, further comprising:
a gasket on the PVC cylinder, said PVC cylinder having a diameter larger than the diameter of the steel rod, said gasket helping provide a seal so that the pressure of the water urges the piston to rise.

15. The device of claim 1, further comprising:
a stake adapted to be driven into the ground, having a plurality of collars adapted to retain the main chamber of the device.

16. The device of claim 1, further comprising:
a stand adapted to retain the main chamber of the device;
a plurality of floats on the stand, each float having a first position wherein the float acts as a floatation device for the device, and a second position for storage.

17. A device to lift a decoy, comprising:
a main chamber;
a piston that extends inside and outside of the main chamber;
an end of the piston outside of the main chamber adapted to connect to the decoy;
a gasket on the piston, inside the main chamber, that helps the pressure of the water urge the piston to rise so that the piston lifts and lowers the decoy, the gasket helping stabilize the piston relative to the main chamber when the piston has risen;
a water pump that provides the main chamber with water under pressure so as to urge the piston to rise; and
a contact switch on the piston that, upon lack of contact between the contact switch and the main chamber, allows the decoy to activate a motion.

18. The device of claim 17, further comprising:
a second piston that rises out of the piston, connected to the decoy, the pressure of the water urging both the piston and the second piston to lift the decoy.

19. A method of simulating a bird in flight and then landing, comprising:
pumping water into a main chamber;
activating a motion for a decoy;
utilizing water pressure in the main chamber to lift a piston attached to the decoy, thereby lifting the decoy;
pressing the water out of the main chamber, thereby lowering the piston and the decoy; and
upon contact between the main chamber and the piston, deactivating the motion for the decoy.

20. The method of claim 19, further comprising:
activating an inner piston that rises out of the piston, connected to the decoy so as to further lift the decoy, the pump providing pressure that urges both the piston and the second piston to rise.
